(19) United States
(12) Patent Application Publication
(10) Pub. No.: US 2014/0075306 A1
(43) Pub. Date: Mar. 13, 2014

(54) Music search and retrieval system

(71) Applicant: Randy Rega, Bridgewater, NY (US)

(72) Inventor: Randy Rega, Bridgewater, NY (US)

(21) Appl. No.: 13/573,366

(22) Filed: Sep. 12, 2012

(51) Int. Cl. G06F 17/30; G06F 3/16

(52) U.S. Cl. 715/716

(57) ABSTRACT

An on-board music search, retrieval and downloadable system has a plurality of musical works, each correlated with a music search code or identifier. The search code or identifier comprises a plurality of information including title, artist, era of song, genre, history of song, and song associations. Any one of the search codes or identifiers identified in an executed search retrieves the musical works associated therewith. The system provides an on-board database in communication with a remote database for searching a plurality of musical works correlated with a music search code or identifier, including a plurality of information such as title, artist, era of song, genre, history of song, and song associations. Any one of the search codes or identifiers identified in an executed search retrieves the musical works. The on-board music system provides easy song retrieval, enabling a driver to search and play songs without being distracted while driving.

### BACKGROUND OF THE INVENTION

1. Field of the Invention

The present invention relates to digital search and retrieval systems; and, more particularly to a computerized music search and retrieval system that operates as an on-board augmentation of a navigation system or the like.

2. Description of the Prior Art

Every year motor vehicle accidents result from drivers distracted by electronic devices in the vehicle. Looking down or away from the road to enter text or read textual details on a hand held computer screen for even an instant while driving can cause a dangerous condition, wherein the driver can swerve out of his/her lane and into oncoming traffic, or swerve off the road. There exists a need in the art for a system that is capable of providing enhanced search and music retrieval capability using a minimum of key strokes, and which can operate by voice command when desired.

Various music data systems with various functionalities are known. Commercial music data systems are available wherein a user manually enters a specific music genre, singer's portfolio, and album or song title when retrieving a song/or songs for purchase into a user's music folder. In turn, the user then has the ability to download the songs from the music folder onto a device having data storage, such as a personal music player including those sold under the trade name IPOD. Other music data systems involve a data program which plays a select music genre, such as pop, country, dance, classical, etc. and the program plays music by artists within that genre. Other devices provide for selecting a specific artist, and music is thus randomly played from that artist as well as other artists with similarly classified music. In any event, these music systems play random music within the genre, and the music is not stored and retrievable on a personal music data system. None of the various music data systems provide an on-board system that allows a user to find a specific song with a plethora of search key words and allow the user to store the song/songs for later playback at his/her discretion. Examples are set forth hereinbelow.

U.S. Pat. No. 4,350,070 to Bahu discloses an electronic music book for simplifying the storage and retrieval of musical scores in which a control panel operates electronic memories to locate a song in the memory for a musician's reading thereof. Optional modules may be added to the memory to expand the library of songs stored by the book. A variety of additional features may be included in the music book, such as audio playback of a selected song, tempo and rhythm control, and a temporary memory for musical works entered through a musical keyboard in the control panel. The book is adapted to be attached to a music stand and may be battery operated for portable use or permanently connected to a source of A.C. voltage. It does not teach an on-board search and retrieval system; instead the patent is directed to an electronic music book that shows music sheets for musicians and the like.

U.S. Pat. No. 5,734,719 to Tsevdosb et al. discloses a digital data on-demand turnkey system at a customer premise wherein N number of sewers provide for 100% of content distribution of remotely stored digitized information. This information may be previewed in real-time, and product incorporating selected digitized information can be manufactured on-site and within a short response time to a customer's request at a point of sale location. The '719 patent is directed to a multimedia manufacturing system and a method for providing media with information which is processed for subsequent playback. The system disclosed by the '719 patent does not disclose an on-board music search and retrieval system.

U.S. Pat. No. 5,739,451 to Winksy et al. discloses a hand held electronic music reference machine comprising a platform having a keyboard and a display for displaying text. A database removably or permanently mounted to the platform has a first memory portion storing, for each of a multiplicity of songs, selected lyrics and identification information including a title. The electronic music reference machine uses a user actuated note structure input means on the platform for providing an input search sequential note structure; the keyboard enables user input of a textual search term. In this manner, the '451 patent provides for a technique that enables one to determine a song title by searching for a sequence of directional changes in successive pitch values (up, down, same) for a melody segment of the song.

U.S. Pat. No. 5,765,152 to Erickson discloses an electronic media packaged in a secure electronic format, and registered on associated registration server, which serves to provide on-line licensing and copyright management for that media. Users are connected to the server, e.g., through a computer network or the Internet, to enable data transfers and to transact licenses to utilize the media. It does not teach a music search retrieval system on-board a vehicle.

U.S. Pat. No. 6,006,218 to Breese et al. discloses an information retrieval method and apparatus which involve: 1) the generation of estimates regarding the probability that items included in search results are already known to the user and 2) the use of such knowledge probability estimates to influence the ranking of search results. It does not teach or disclose an on-board music search, retrieval and downloadable system for selectively accessing a plurality of musical works with minimum distraction to the motor vehicle operator.

U.S. Pat. No. 6,175,071 to Ito discloses a music apparatus that provides a music performance according to performance data. In the music apparatus, an input section inputs performance data composed of a header part and a body part containing music sequence data associated to a music performance. The '071 patent does not disclose an on-board music search, retrieval and downloadable system for selectively accessing a plurality of musical works with minimal distraction while driving.

U.S. Pat. No. 6,697,796 to Kermani discloses a technique and apparatus to allow a digital search of the entries in a digital audio database such as the Flash memory of a telephone answering system, the hard drive of a voice messaging system, the audio tracks on a compact disk, a cassette tape, a digital video disk (DVD), a videotape, etc. It does not disclose an on-board music search, retrieval and downloadable system for selectively and safely accessing a plurality of musical works during operation of a motor vehicle.

U.S. Pat. No. 6,718,308 to Nolting discloses a system and method for searching, assembling, and manipulating a variety of multi-media using voice converted to text commands. Digital images, movies, audio, or text is verbally searched and retrieved from a variety of video and audio databases using a combination of directional commands and a means for juxtaposing and assembling search results. The desired media is then placed onto a platform means for manipulating and editing the media files. The '308 patent does not disclose an on-board music search, retrieval and downloadable system wherein a plurality of musical works can be accessed safely, with minimum distraction by the driver of a motor vehicle.

U.S. Pat. No. 6,953,886 to Looney et al. discloses a media organizer and entertainment center includes an importer for importing individual media/data selections and automatically assigning each selection at least one associated category flag pursuant to predetermined or user defined criteria. A significant feature of the center is the organization of media/data, such as individual songs or selections, according to specific categories, that are determined ahead of time, on a partially subjective basis, by the service provider. The '886 patent does not disclose an on-board music search, retrieval and downloadable system for selectively accessing a plurality of musical works, wherein any one of the search codes or identifiers developed by an executed search retrieves the musical works.

U.S. Pat. No. 7,127,454 to Deguchi discloses a method and system for providing a data marking device data searching system. A user terminal connected to a server terminal over an interne connection transmits a music search request. The server terminal in response accessing one or more storage units and retrieves corresponding information such as other marked data for transmission to the user terminal. The method and system identifies, locates and shares bookmarked music clips; it does not provide an on-board music search, retrieval and downloadable system for selectively accessing one or more music works with minimum distraction to driving duty.

U.S. Pat. No. 7,227,071 to Tagawa discloses a music search system for conducting a music search, which allows the user to easily listen to music matched to a situation. The music search system includes a music data storage section, a location acquisition section, a parameter converting section, a music search section, and a reproducing section. The '071 patent does not disclose an on-board music search, retrieval and downloadable system wherein a plurality of musical works are correlated with a plurality of information search identifiers.

U.S. Pat. No. 7,313,591 to Eames et al. discloses methods, computer readable mediums and systems that provide media player users with a full contextual metadata experience. Metadata include multiple forms of property data, or information, relating to media accessed by a media player, such as a CD in a CD-ROM drive of a computer. The '591 patent does not disclose an on-board music search, retrieval and downloadable system wherein a plurality of musical works can be accurately and safely correlated with a plurality of information search identifiers.

U.S. Pat. No. 7,629,529 to Makino discloses a music-piece retrieval and playback apparatus, and related method wherein impression words express impressions about music pieces and are separated into groups called impression axes. Impression words in each of the impression axes have meanings mutually related with each other. The music-piece retrieval and playback apparatus allows the user to search for a desired music piece while utilizing a now-playing music piece as a reference; it involves impression-data and now-playing data in its search. The '529 patent does not disclose an on-board music search, retrieval and downloadable system in which a plurality of musical works can be quickly and safely correlated with a plurality of information search identifiers.

U.S. Pat. No. 7,823,055 to Sull discloses a method and system are provided for tagging, indexing, searching, retrieving, manipulating, and editing video images on a wide area network such as the Internet. A first set of methods is provided for enabling users to add bookmarks to multimedia files, such as movies, and audio files, such as music. The '055 patent does not disclose an on-board music search, retrieval and downloadable system for safely and accurately locating and retrieving a plurality of musical works while driving a motor vehicle.

U.S. Pat. No. 8,161,056 to Kobayashi et al. discloses a music information database, music information where music pieces and impression words representing impressions of the music pieces and usable as search words when any of the music pieces is to be searched for is registered for a plurality of music pieces. Information collection section collects, from among various information being provided by information source sites, information usable as music-piece-related search words. The music information database provides for search query as to music pieces and impression words of music pieces. It does not teach or disclose an on-board music search, retrieval and downloadable system wherein a plurality of musical works can be safely and accurately correlated with a plurality of information search identifiers during operation of a motor vehicle.

U.S. Pat. No. 8,163,990 to Adam et al. discloses a method for recording and compiling a music section, wherein multiple takes of the music section are recorded; and wherein the method uses a take folder to store the multiple takes. The take folder may belong to a single track. Sections of one or more takes can be selected to be part of a resulting compilation which is composed of the selected sections. The method comprises the steps of recording and compiling a music section, wherein multiple takes of the music section are recorded; and wherein the method uses a take folder to store the multiple takes. The '990 patent does not disclose an on-board music search, retrieval and downloadable system in which a plurality of musical works can be safely and accurately correlated with a plurality of information search identifiers during operation of a motor vehicle.

U.S. Patent Application Publication No. 20020041692 to Seto et al. discloses an audio system and a method for to a vehicle driver music, matched to driver's favorite preferences. Music related information is inputted into an information storage section, and favorite information with respect music is detected by a favorite information detecting section. The detected favorite information is analyzed by a favorite analysis section, and analyzed resultant data is stored in the information storage section. Music data includes music titles with favorite degree indicators. Music data includes information which has contents in the music pieces; it does not teach or disclose related historical/popular content. The '692 patent application publication does not disclose an on-board music search, retrieval and downloadable system having a plurality of musical works correlated with a plurality of information search identifiers.

U.S. Patent Application Publication No. 20070030980 to Goodman et al. discloses a method of recording a recommended plurality of audio signals in an entertainment sound system associated with an automotive vehicle. A central server processes a plurality of data associated with a plurality of audio signals. The method effectively pauses a live radio broadcast for a selected time period. Selective recording of audio signals congruent to previous audio signals listened to by the user are also provided. The '980 patent application publication does not disclose an on-board music search, retrieval and downloadable system wherein a plurality of musical works can be safely and accurately correlated with a plurality of information search identifiers during operation of a motor vehicle.

U.S. Patent Application Publication No. 20080016081 to Macmillan et al. discloses a system and method for automatic digital library creation. One aspect of the invention involves a computer-implemented method in which a storage server in a LAN of a user: automatically receives content from a client device in the LAN. The received content is determined in accordance with a storage server profile for the storage server, and receiving content frees up storage space on the client device; stores at least some of the content received from the client device; automatically receives content via an external network that is complementary to the stored content received from the client device, wherein the complementary content is determined in accordance with the storage server profile; and stores the complementary content. The '081 patent application publication does not disclose an on-board music search, retrieval and downloadable system wherein a plurality of musical works can be correlated with a plurality of information search identifiers in a safe, accurate manner during operation of a motor vehicle.

U.S. Patent Application Publication No. 20080189354 to Narasimhan et al. discloses a method and apparatus that creates reviews of media content on a mobile communication device. The method may include identifying media content being played for a user, receiving a review from the user based on the played media content, and sending the user's review to a remote media content server for processing. The '354 patent application publication does not disclose an on-board music search, retrieval and downloadable system in which a plurality of musical works is correlated with a plurality of information search identifiers in a safe, accurate manner during operation of a motor vehicle.

U.S. Patent Application Publication No. 20090022330 to Haulick et al. discloses a method for processing sound signals in a vehicle multimedia system. A sound signal is recorded by a microphone. A voice signal component resulting from reproducing a voice signal and an audio signal component resulting from reproducing an audio signal are compensated in the recorded sound signal. A method for processing sound signals in a vehicle multimedia system is provided, comprising: detecting a sound signal with a microphone, where the sound signal has a first voice signal component that corresponds to a voice signal, a second voice signal component that results from a loudspeaker, and an audio signal component resulting from an audio signal. The 330 patent application publication does not disclose an on-board music search, retrieval and downloadable system wherein a plurality of musical works can be correlated with a plurality of information search identifiers in a safe, accurate manner with minimal distraction to driving duty during operation of a land vehicle.

Foreign Patent Publication No. JP3482398 to Nachmani discloses a voice inputted by a user of an interactive interface. The voice is recognized, and a recognition character string is generated. The '398 foreign patent publication does not disclose an on-board music search, retrieval and downloadable system that safely and accurately correlates a plurality of musical works with a plurality of information search identifiers.

Foreign Patent Publication No. EP1785891 to Stanley et al. discloses a music information retrieval system using a 3D search algorithm. The '891 foreign patent publication does not disclose an on-board music search, retrieval and downloadable system wherein a plurality of musical works can be safely and accurately correlated with a plurality of information search identifiers.

Non-Patent Literature entitled “XM XPMP3H1 PORTABLE SATELLITE RADIO AND MP3 PLAYER (XMp3i)” found at http://www.amazon.com/XPMP3H1-Portable-Satellite-Radio-Player/dp/B003E7ES4A/ref=sr_{—}1_{—}1?s=electronics&ie=UTF8&qid=134 0225452&sr=1-1 discloses a Portable Satellite Radio. The publication teaches a satellite radio for use on the go, such as in a vehicle. No disclosure is contained in the non-patent literature publication concerning an on-board music search, retrieval and downloadable system wherein a plurality of musical works can be correlated with a plurality of information search identifiers in a safe, accurate manner with minimal distraction to the driver of a motor vehicle.

Notwithstanding the efforts of prior art workers to provide improvements to music data systems, there remains a need in the art for an on-board music search and retrieval system that allows a user to find a specific song with a minimum number of searching key words, and to store the song/songs for later playback at his/her discretion. A sizeable reduction in the time during which a driver diverts his focus from the road is facilitated, as the music data search, retrieval and listening steps are achieved in a highly efficient manner. This, in turn, minimizes distraction from driving duties and improves safety conditions for the driver, passengers, other vehicles, and pedestrians. There accordingly remains a need in the art for an on-board music search, retrieval and downloadable system having a plurality of musical works, each correlated with a music search code or identifier, the search code or identifier comprising a plurality of information including title, artist, era of song, genre, history of song, and song associations, wherein any one of the search codes or identifiers identified in an executed search retrieves the musical works associated therewith. Such a system would advantageously provide the ability for a driver to locate his/her desired music with minimal keystrokes and searching, thereby minimizing distraction from driving duties, increasing the margin of safety during driving, and reducing land vehicle accidents.

### SUMMARY OF THE INVENTION

The present invention relates to an on-board music search, retrieval and downloadable system having a plurality of musical works, each correlated with a music search code or identifier, the search code or identifier comprising a plurality of information including title, artist, era of song, genre, history of song, and song associations, wherein any one of the search codes or identifiers identified in an executed search retrieves the musical works associated therewith. The music search codes are stored in a local database to be accessed from a remote database. The remote database data can be used in combination with data from a local database to direct the user to the address that corresponds to the code.

On-board augmentation of a navigation system is provided that enables a vehicle occupant to verbally or with a limited number of key strokes request a song which can then be found and displayed on the system's screen. Once the song is displayed it can be locked in and played in the vehicle. The song is then stored on an on-board database within the vehicle. Songs that are requested and not found in the on-board data base can be accessed via the Internet (which has access to a large relational database of many different kinds of songs). The system has safety features in addition to facilitating access to musical selections, in that such access can be obtained with a minimum number of key strokes.

During operation of the music search and retrieval system of the subject invention, a personal data assistant triggers retrieval of a song/album/list of queried songs quickly and with minimal distraction to vehicular driving duties. This, in turn, enables the margin of safety for the driver, passengers and others in the vicinity of the vehicle to be substantially increased. These advantages are inherent to the music search and retrieval system of my invention, and are uniquely provided thereby.

The music search and retrieval system comprises a plurality of musical works, each correlated with a music search code or identifier. The search code or identifier comprises a plurality of information including title, artist, era of song, genre, history of song, and song associations. Any one of the search codes or identifiers identified in an executed search retrieves the musical works associated therewith. A local/on-board database for collecting the musical works and unique search code identifiers, and correlating and storing each of the musical works with unique search code identifiers. The database which may be a remote Internet database or local database, is in communication with an on-board database system so that upon entry of the search for the musical work initiated by entry of the unique search code identifier. A musical work/list of musical works is displayed enabling a user to then select the desired musical work and listen to the song/and/or download the selected musical work onto the on-board database system for later listening for a period of time. A voice activated search means is integrated within the database for voice search when using the system on-board when operating a vehicle for safety. The on-board database system has Internet connectivity, a local database, an internal music database, display monitor, memory, processor, software generated or hardware data entry keyboard, sound input, sound output. An easily accessible activation key is provided for activating music search and selection.

Activating the music search and selection is achieved through pressing the activation key or using voice activation on the on-board database system and input of one or more search code identifiers through voice/speech or text retrieves a desired musical work within a short time period, thereby mitigating loss of attention during driving and increasing driving safety.

### BRIEF DESCRIPTION OF THE DRAWINGS

The invention will be more fully understood and further advantages will become apparent when reference is made to the following detailed description of the preferred embodiments of the invention and the accompanying drawing, in which:

FIG. 1 illustrates a schematic overview of the subject on-board music search and retrieval system; and

FIG. 2 illustrates an overview of the operation of the subject on-board music search and retrieval system—showing an example of an audible search and retrieval, and audible results delivery.

### DETAILED DESCRIPTION OF THE INVENTION

On-board music players have become integral in many newer vehicles. When not manufactured within the vehicle, upgraded or enhanced systems can be readily purchase as portable add-ons appointed to be mounted within the vehicle. Commercial music data systems are available wherein a user manually enters a specific music genre, singer's portfolio, and album or song title when retrieving a song/or songs for purchase into a user's music folder. In turn, the user then has the ability to download the songs from the music folder onto a device having data storage, such as a personal music player, including those sold under the trade name IPOD. Other music data systems involve a data program which plays a select music genre, such as pop, country, dance, classical, etc. and the program plays music by artists within that genre. Other devices provide for selecting a specific artist; and music is thus randomly played from that artist as well as other artists with similarly classified music. In any event, these music systems play random music within the genre, and the music is not stored and retrievable on a personal music data system. None of the various music data systems provide an on-board system that allows a user “lock in” a song with a single key stroke, or to find a specific song with a minimum of search key words, and store the song/songs for later playback at his/her discretion.

Conventional systems require many keystrokes, which are not carried out in a safe, time efficient manner, while driving. Moreover, many of the systems only offer limited search query ability—such as title of song, songs by artists, etc., and do not provide an extensive, exhaustive measure for finding a particular song title a user is searching for. When the vehicle is being operated, it is unsafe for a driver to be distracted with a music system—let along attempting to find a song on the tip or his/her tongue, or of which the driver may be vaguely aware, or attempting to remember. There exists a need in the art for a set of codes that uniquely identify any song, so that a user can simply enter a unique identifier that correlates with the song being searched, thereby avoiding the need for cumbersome, time consuming and oftentimes distracting procedures otherwise required. The music search and retrieval system of the present invention solves this problem by associating unique song search code identifiers with each song or songs of interest so that searching and retrieval is accomplished using a minimum number of keystrokes or by speech, with minimum attention diverted from driving duties.

As a result, a user of the subject system and method can find songs based on a minimum amount of information or search code. It is also possible for the user of the subject system to “lock-in” and record a song using a single key stroke or by uttering a single word (such as “lock”) while driving. The subject system and method further includes a database for collecting the musical works and unique search code identifiers, and correlating and storing each of the musical works with unique search code identifiers. The database of the subject system and method may be a remote or local database that is in communication with an on-board database system so that upon entry of the search for the musical work initiated by entry of the unique search code identifier, a musical work/list of musical works is displayed, enabling a user to then select the desired musical work and listen to the song/and/or download the selected musical work onto the on-board database system for later listening at a preferred time. Furthermore, the subject system and method provides for voice activated search means integrated within the database for voice search when using the system on-board when operating a vehicle for safety.

An on-board augmentation of a navigation system or the like is provided that enables a vehicle occupant to verbally or with a limited number of key strokes request a song which can then be found and displayed on the system's screen. Once the song is displayed it can be locked in and/or recorded and played in the vehicle. The song is then stored on an on-board database within the vehicle. Songs that are requested and not found in the on-board data base can be accessed via the Internet (which has access to a large relational database of many different kinds of songs). The system has safety features in addition facilitating access to musical selections, in that such access can be obtained with a minimum number of key strokes.

An on-board augmentation of a navigation system or the like is provided that enables a vehicle occupant to verbally or with a limited number of key strokes request a song which can then be found and displayed on the system's screen. Once the song is displayed it can be locked in and played in the vehicle. The song is then stored on an on-board database within the vehicle. Songs that are requested and not found in the on-board data base can be accessed via the Internet (which has access to a large relational database of many different kinds of songs). The system has safety features in addition facilitating access to musical selections, in that such access can be obtained with a minimum number of key strokes or by uttering a voice command.

During operation of the music search and retrieval system of the subject invention, a personal data assistant triggers retrieval of a song/album/list of queried songs quickly and with minimal distraction to vehicular driving duties. This, in turn, enables the margin of safety for the driver, passengers and others in the vicinity of the vehicle to be substantially increased. These advantages are inherent to the music search and retrieval system of the subject invention, and are uniquely provided thereby.

On-board augmentation of a navigation system is provided that enables a vehicle occupant to verbally or with a limited number of key strokes request a song which can then be found and displayed on the system's screen. Once the song is displayed it can be locked in and played in the vehicle. The song is then stored on an on-board database within the vehicle. Songs that are requested and not found in the on-board data base can be accessed via the Internet (which has access to a large relational database of many different kinds of songs). The system has safety features in addition facilitating access to musical selections, in that such access can be obtained with a minimum number of key strokes or via voice command without diverting the driver's attention from objects such as pedestrians, oncoming traffic and the like in the vicinity of the vehicle.

This invention relates to Boolean search codes/music search code libraries that correlate to any song or album. One of these music search codes is entered into or spoken into an on-board music database system. After pressing a request button or activating a request verbally, the request including a search indicator such as a name of a singer, song writer, band, song, or various words in a song, or another indicator, the system shows the name or names of uncovered songs. The user then selects the desired song from the search library list and the user can immediately listen to the song, and/or download the song onto an on-board database for storage. The music search and retrieval system broadly comprises: (i) a plurality of musical works, each correlated with a music search codes or identifiers, which are previously entered through software generated or hardware keyboard or communicated by speech; (ii) a database for collecting the musical works and unique search code identifiers, and correlating and storing each of the musical works with unique search code identifiers; (iii) the database which may be a remote or local database, being in communication with a an on-board database system so that upon entry of a search for a musical work initiated by entry of a unique search code identifier, a musical work/list of musical works is displayed enabling a user to then select the desired musical work and listen to the song/and/or download the selected musical work onto the on-board database system.

Generally stated, the invention comprises a main music database system that is in communication with an on-board database system having a display, preferably an LCD display, memory, preferably both ROM for the software needed to communicate with the main music database system, retrieve search lists therefrom, and play and download songs/music from the search list and RAM to store user entered searches, contracted references and search words assigned to each of the plurality of musical works. The music database device has a processor which processes the song data, as well as a corresponding search codes for each song, entered through keyboard or provided as speech recorded through a microphone, for storage in a plurality of (typically three) separate linked databases within the device. This database collection may be a combination of local database collection in combination with a remote database accessed through the Internet. This link between entries allows the retrieval of the address upon keyboard entry of a small number of characters, or previously assigned speech pattern, of the music search code. In order to enter into this search pattern, an activation key is pressed in the device and retrieved songs/music are accepted by the user by pressing the special key. The retrieved song/music is passed to the on-board processor and the device downloads the song.

Generally stated, the invention comprises a main music database system that is in communication with an on-board database system having a display, preferably an LCD display, memory, preferably both ROM for the software needed to communicate with the main music database system, retrieve search lists therefrom, and play and download songs/music from the search list and RAM to store user entered searches, contracted references and search words assigned to each of the plurality of musical works. The music database device has a processor which processes the song data, as well as a corresponding search codes for each song, entered through keyboard or provided as speech recorded through a microphone, for storage preferably in three separate linked databases within the device. This database collection may be a combination of local database collection in combination with a remote database accessed through the Internet. This link between entries allows the retrieval of the address upon keyboard entry of a small number of characters, or previously assigned speech pattern, of the music search code. In order to enter into this search pattern, a special key is pressed in the device and retrieved songs/music are accepted by the user by pressing the special key. The retrieved song/music is passed to the on-board processor and the device downloads the song.

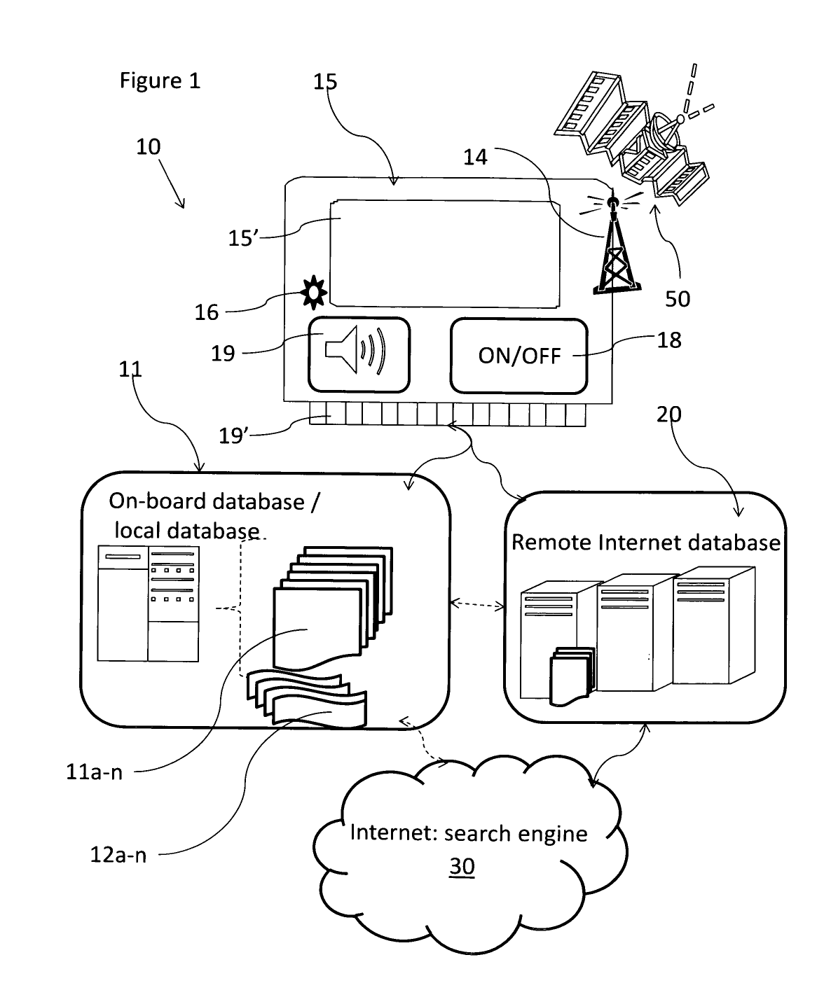

FIG. 1 illustrates a schematic overview of the music search and retrieval system, shown generally at 10. The music search and retrieval system 10 broadly comprises an on-board database device 11 with a local database that has a plurality of songs/music 11a-n each correlated with a unique music search code 12a-n. Such code 12a-n typically is a song title or the like stored in the local database or in the remote internet database 20. Moreover, local database 11 and system 10 is capable of communication with the Internet via broadband carrier service and/or Wi-Fi service so that a search can be initiated via an Internet search engine 30 for song retrieval.

Song 11a is correlated with at least one unique music search code 12a and assigned speech pattern 13a. Preferably, each song 11a-n is correlated with a plurality of different music search codes 12a so that each song 11a-n can be retrieved based on varying search codes 12a-n. For example, the artist Michael Jackson's song entitled “Bad” includes more than one music search codes 12a-n: 1) song title and/or song with the word “BAD” in it; 2) songs by Michael Jackson; 3) song from a beverage or soda commercial; etc.

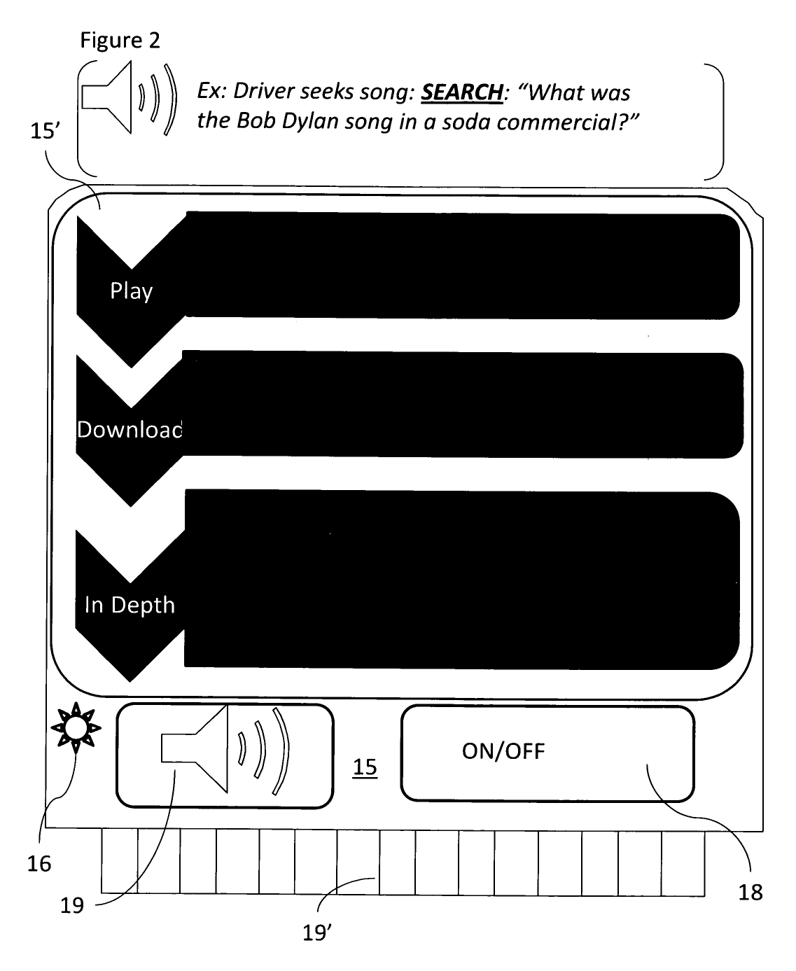

The local database 11 is in communication with on-board database device 15 or a main music database system so that when a user enters a search using software generated voice recognition or hardware keyboard entry querying a stored code into their vehicle/personal on-board database device 15, the song 11a-n (11a) appears on the system 15. Ability to select the song is yielded to the user. (See FIG. 2 for example). Each of the songs 11a-n, such as genre, title, lyrics, history, will be assigned a code or unique search both in the on-board database device 15 and a remote access music database system server 20.

In operation, for example, while driving down the highway, a user hears a song that he wishes to preserve for listening at a preferred time. The user simply speaks the word “lock” or presses a single key or button on the device, and thereby locks-in and records the song for access and listening at a preferred time. In operation of another aspect of the system, the system is prompted to search a song. In this aspect of the system the user does not remember the singer/band and/or title; but the system prompt is based on a lyric or the like which the user enters via voice command or key stroke. The system's on-board database 11 is searched, followed simultaneously by search via remote Internet database 20, which also includes an Internet search engine. The remote access music database system server 20 collects the song/songs that correspond to the search and stores the information in the local database 11 for selection by the user. Next, the user selects the desired song from the local database 11 via the on-board device 15, and the user can listen to the song immediately and/or select downloading of the song to add the song to a music library in the on-board database device 15. Once a user triggers a “look up” for a certain song using the remote access database 20, the resultant data is streamed, downloaded and/or stored in the local database 11.

A membership fee may be paid on a monthly/annual basis for use of the system and to cover royalties associated with the downloading and recording of music on the system. Instead, a single use fee (0.99 cents, etc.) can be paid by the user per download. Advertisements may be streamed onto the screen during a search as the system 10 is retrieving a song or performing a search. Such advertising space can be paid for by advertising sponsors as a means for generating funding and/or profits for the system 10 management or operating platform.

The system 10 receives data from satellite 50. Thus, the process for entering songs/searcher or speaking into a microphone in accordance with a previously assigned speech pattern in the system is dramatically simplified and thereby converted to a much more efficient process. The song search mode is activated by pressing an activation key 18; speech activation search may be activated via pressing a voice search key 19; each shown in this case as buttons. Instead, system display 15′ may be provided as a tough screen display with each key available for pressing. The user may voice command the search or enter a unique search identifier, such as song title, lyric, a predominant word in the song, song history, artist, etc. through a keyboard 19′ or speaking into a microphone 16, at which point, the monitor displays the search.

The user accepts the search by pressing the activation key 18 and the remote access music database system server 20 searches for the selected search code. When the activation key 18 is pressed by the user, the device enters the search mode and waits for the user's input for the search code or previously recorded speech patterns through microphone 16. Upon receipt of the search code, the device retrieves the song and displays the song/songs on the monitor. The user selects the desired song by pressing the activation key again, and downloads the song onto the on-board database 11. The system communicates with the satellite using the antenna 14. In the figure shown, the same antenna is used to communicate with the Internet for accessing Internet based remote database 20 or to access search engines 30, such as that used under the trade name Google. The remote server 20 is also provided with antenna 14 for Internet connection; this may be a hard wired connection.

FIG. 2 illustrates an overview of the operation of the subject on-board music search and retrieval system—showing an example of an audible search and retrieval, and audible results delivery. Boolean search codes/music search code libraries are provided that correlate to any song or album. One of these music search codes is entered into or spoken into an on-board music database system. After pressing a request button or activating a request verbally, said request including a search indicator such as a name of a singer, song writer, band, song, or various words in a song, or another indicator, the system shows the name or names of uncovered songs. In the example shown, the user initiates a voice search for a song he/she wants to identify or that he/she cannot quite remember: Search “What was the Bob Dylan song in a soda commercial?” Upon initiation of the search the local database 11 search is executed for words “Bob Dylan” and “songs in commercials”, specifically “soda commercials” or/“beverage commercials”. If the local database 11 does not retrieve a match, the system immediately begins the search execution on the remote Internet database 20 and simultaneously on Internet search engine 30. Upon retrieval of a match the results are streamed onto the local database 11 and shown on screen 15′ of device 15. The results are preferably audibly communicated to the driver so the driver does not have to look down and read the results on screen 15′.

Results of the example are shown on screen display 15′. Preferably the results provide not only the resultant song, but options for the user as well. Herein, the results indicated: song “Forever Young” by Bob Dylan; feat Will.i.am. The user can select “play” and have the song downloaded for streaming listening; The user can select “download” for immediate play and for download and saving the song onto the on-board database 11; The user can select “in depth” for more options, such as having the lyrics downloaded into the database 11, and/or having the lyrics sent via a text message or as a file to a cellular phone or email account; karaoke version for on-board system; more information—streaming audio history of song and/or artist; all remakes of the song; and/or similar songs/more from Bob Dylan.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. A music search and retrieval system comprising:
a. a plurality of musical works, each correlated with a music search code or identifier;
b. said search code or identifier comprising a plurality of information including title, artist, era of song, genre, history of song, and song associations, wherein any one of said search codes or identifiers identified in an executed search retrieves said musical works associated therewith;
c. a local/on-board database for collecting said musical works and unique search code identifiers, and correlating and storing each of said musical works with unique search code identifiers;
d. said database which may be a remote Internet database or local database, being in communication with an on-board database system so that upon entry of said search for said musical work initiated by entry of said unique search code identifier, a musical work/list of musical works is displayed enabling a user to then select the desired musical work and listen to the song/and/or download the selected musical work onto the on-board database system for later listening at a preselected time; and
e. voice activated search means integrated within said database for voice search when using said system on-board when operating a vehicle for safety;
f. said on-board database system having Internet connectivity, a local database, an internal music database, display monitor, memory, processor, software generated or hardware data entry keyboard, sound input, sound output and an activation key for activating music search and selection.
whereby activating said music search and selection is achieved through pressing said activation key or using voice activation on said on-board database system and input of one or more search code identifiers through voice/speech or text retrieves a desired musical work within a short time period, thereby mitigating loss of attention during driving and increasing driving safety.

2. The music search and retrieval system as recited by claim 1, wherein said local on-board database includes user data of user generated musical searches and musical works and a corresponding music search code reference to each of the musical works.

3. The music search and retrieval system as recited by claim 1, wherein said voice activated search means includes a voice recognition local database including a speech pattern of sounds for each of the music search codes.

4. The music search and retrieval system as recited by claim 1, wherein said activation key for activating music search and selection is operative upon pressing it or through voice activation, to thereby enter search, retrieval or play mode whereupon a desired song is retrieved from the stored local database and displayed on the monitor when a few music search code characters are typed or spoken.

5. The music search and retrieval system as recited by claim 1, wherein said remote database is maintained by an operator or other representative of the system.

6. The music search and retrieval system as recited by claim 1, wherein said song associations comprising said search code or identifier includes a predominant lyric or musical beat within a musical work.

7. The music search and retrieval system as recited by claim 1, wherein said search code or identifier includes famous features of a musical work.

8. The music search and retrieval system as recited by claim 1, wherein said search code or identifier includes date ranges for a musical work's era.

9. The music search and retrieval system as recited by claim 1, wherein said search code or identifier includes a category of songs/musical works used in commercials/advertisements.

10. The music search and retrieval system as recited by claim 1, wherein a smart phone application is provided that enables communication of said system on said smart phone when outside of the vehicle.

11. The music search and retrieval system as recited by claim 1, wherein the remote database has an operator that can create, store and track musical search identifiers that correlate with said search codes.

12. The music search and retrieval system as recited by claim 1, wherein said musical work is retrieved by either entering keystrokes of search codes or by speaking a speech pattern of sounds after activating music search mode by pressing said activation key.

13. The music search and retrieval system as recited by claim 1, wherein the music search codes are pre-programmed by the user prior to driving in an automobile.

14. The music search and retrieval system as recited by claim 1, wherein said activation key is located in a highly accessible location.

15. The music search and retrieval system as recited by claim 1, wherein at least one advertisement is streamed online to said on-board database when a search is activated.
